(19) United States
(12) Patent Application Publication
(10) Pub. No.: US 2013/0036035 A1
(43) Pub. Date: Feb. 7, 2013

(54) System And Method For Automation Of Law Firms

(71) Applicant: Jonathan Dever, Cincinnati, OH (US)

(72) Inventor: Jonathan Dever, Cincinnati, OH (US)

(73) Assignee: Togiac Enterprises Ltd., West Chester, OH (US)

(21) Appl. No.: 13/195,983

(22) Filed: Aug. 2, 2011

(51) Int. Cl. G06Q 50/00; G06Q 30/00

(52) U.S. Cl. 705/32; 705/311

(57) ABSTRACT

According to an embodiment, a computer automated system for automating a law firm comprises a processor and a memory. The processor and the instructions encoded in the memory enable the system to control user access by means of a user interface. The system further generates user-specific parameters for allowing a user access to specific files, manages a specific user's time and control a document generator, a conflict resolver, a service resolver, the time keeping manager and a plurality of servers for registering and resolve a case for a judge in a court room for hearing and presenting judgments. In one embodiment, a method for a computer automated system comprises the steps of controlling user access via a user interface, generating user-specific parameters, a court room, managing a specific user's time and controlling a document generator, a conflict resolver, a service resolver, the time keeping manager, and a plurality of servers.

### FIELD OF INVENTION

The invention relates to law firm practices and more particularly to computer automated systems and methods for automation of law firms as well as in areas delivering services in related fields.

### BACKGROUND

Current practice among service provider firms such as real estate, legal, consulting, etc. entails a customer referral engine that is meant to bring client business to the firm. Typically, a real estate consultant/broker, attorney, or other practitioner meets the client and carries out a set of tasks. In the case of legal services, usually, tasks are performed before and after the matter comes up for hearing in a courtroom, before a judge or/and jury.

The processes involved in the tasks that a law firm executes begin with registering a client, and case details. Often, specific client cases have a generic component which is generally repetitive in nature. The repetitive component is usually related not only to generating a set of documents that are applicable to a particular case but also includes administrative tasks carried out in the course of business. However, law firms and other practices do not have tools to quantify time spent on repetitive tasks, administrative tasks or a means to cut down on time spent repeating tasks that can be automated and evaluate whether time spent on a client matter or administrative task is profitable.

In the present scenario, to automate a law firm practice, a law firm must do more than merely paper based processes that are repetitive in nature with computers. Mere computerization of tasks is not sufficient as it may not serve to increase efficiency or effectiveness and automate tasks and functions associated with the business of law. The inability of the law firm to cut down on repetitive practices in the time consuming jobs often limits an attorney to handling the same type of task or cases i.e. divorces only, real estate only, etc. The firm spends a substantial amount of time repeating the task that consumes the productive time of the attorney, and support staff. The practitioner needs to cut down on the time-consumed in the tasks and increase their efficiency and effectiveness while maintaining client confidentiality. Therefore, there exists a need to address the above mentioned issues.

### SUMMARY

Embodiments of the present disclosure described herein provide a system and method to automate the work and business of a law firm.

According to an embodiment of the present invention, a computer automated system for automating the working of a service provider firm such as a law firm comprises a processor and a memory that has instructions encoded thereon, and which instructions cause the computer automated system to control user access by means of a user interface. The automated computer system further generates user-specific parameters for allowing a user access to specific files, manages a specific user's time via a time keeping manager and controls, via the file management system, at least one of a document generator, a conflict resolver, a service resolver, the time keeping manager and a plurality of servers for registering a user completing internal process checks, to schedule an appointment with a practitioner or attorney, provide live feedback on works in progress, and resolve a case before a judge in a court room for hearing and presenting judgments and an interface that coordinates the filing of documents with clerks of court. The system provides data reporting tools to validate and consider best practices through a business intelligence and reporting function thereby allowing the business to run more effectively through configuration of processes to generate the desired business result.

An embodiment includes, in a computer automated system comprising a processor and a memory with instructions encoded thereon, a method comprising the steps of controlling user access to the system via a user interface, generating user-specific parameters by a file management system application for user specific access, managing a specific user's time via a time keeping manager; and controlling at least one of a document generator, a conflict resolver, a service resolver, the time keeping manager, and a plurality of servers for registering a user completing internal process checks, to schedule an appointment with a practitioner or attorney, provide live feedback on works in progress, and resolve a case before a judge in a courtroom for hearing and presenting judgments and an interface that coordinates the filing of documents with clerks of court. The system provides data reporting tools to validate and consider best practices through a business intelligence and reporting function, thereby allowing the business to run more effectively through configuration of processes to generate the desired business result.

### BRIEF DESCRIPTION OF FIGURES

In the accompanying figures, similar reference numerals refer to identical or functionally similar elements. These reference numerals are used in the detailed description to illustrate various embodiments and to explain various aspects and advantages of the present disclosure.

FIG. 1 illustrates a schematic architecture of an automated law firm.

FIG. 2 illustrates a block diagram of a file management system in the automation of law firms.

FIG. 3 illustrates a block diagram of the document generator in the automation of law firms.

FIG. 4 illustrates a block diagram of the jurisdiction identifier.

FIG. 5 illustrates the working of the file management system in the automated law firm.

FIG. 6 illustrates a block diagram of the time block scheduling system.

FIG. 7 illustrates a block diagram illustrating the working of videoconferencing application.

FIG. 8 illustrates a block diagram of the conflict resolver.

FIG. 9 illustrates a block diagram of the service resolver.

FIG. 10 illustrates a block diagram of the time keeping manager.

FIG. 11 illustrates an example of the different categories of time types for a use.

FIG. 12 illustrates the method of automation of a law firm.

Persons skilled in the art will appreciate that elements in the figures are illustrated for simplicity and clarity and have not been drawn to scale. For example, the dimensions of some of the elements in the figure may be exaggerated relative to other elements to help to improve understanding of various embodiments of the present disclosure.

### DETAILED DESCRIPTION

It may be observed that the components of the system and method steps have been represented by conventional symbols in the figures, showing only specific details which are relevant for an understanding of the present disclosure. Further, details readily apparent to a person having ordinarily skill in the art may not have been disclosed. In the present disclosure, relational terms may be used to distinguish one entity from another entity, without necessarily implying any actual relationship or order between such entities.

Embodiments of the present disclosure described herein provide a system and method to automate the working of a law firm.

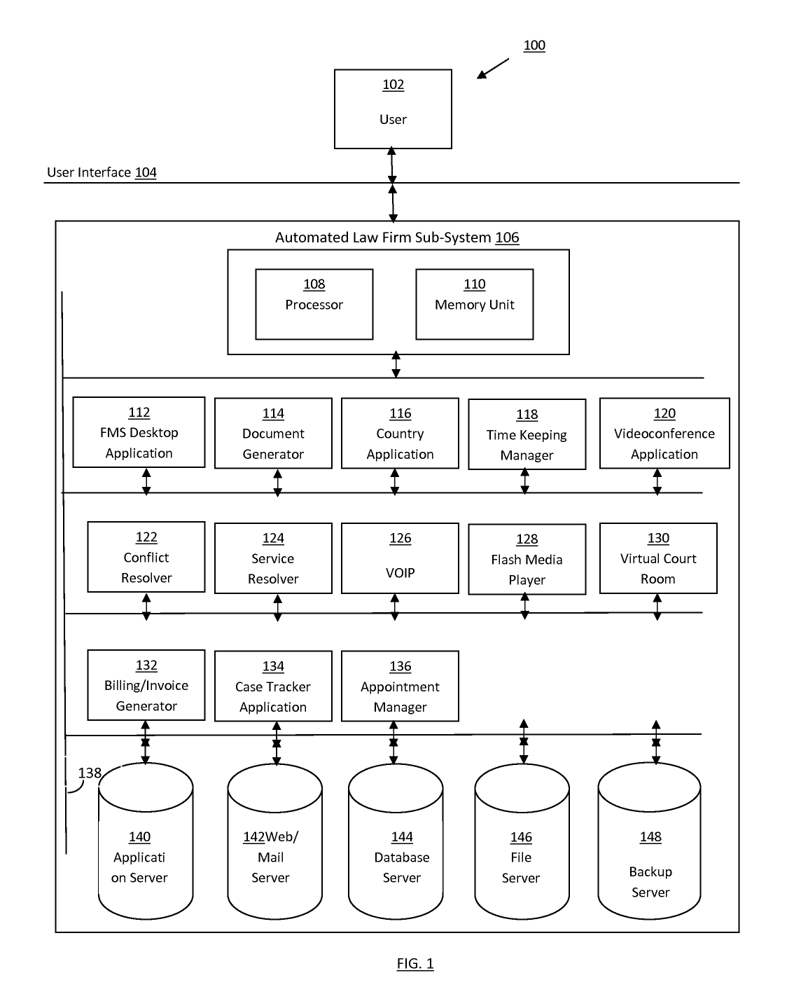

FIG. 1 illustrates a schematic architecture of an embodiment. Shown in FIG. 1 is a system 100 for automating a law firm, and a user 102 communicating with the system through user interface 104. A sub-system 106 comprises a user interface 104, a processor 108, a memory unit 110 having instructions encoded thereon, a File Management System (FMS) desktop application 112, a document generator 114, a country application 116, a time keeping manager 118, a videoconference application 120, a conflict resolver 122, a service identifier and resolver 124, a VOIP (Voice Over Internet Protocol) application or third party VOIP application service provider 126, flash media player 128, a virtual court room application 130, a billing/invoice generator 132, a case tracker application 134, an appointment manager 136, a plurality of servers including an application server 140, a web/mail server 142, a database server 144, a file server 146, a backup server 148 and a system bus 138 that connects all the components of the subsystem 106 with the plurality of the servers and enables synchronizing the servers. The system further comprises a block scheduler that is configured to perform time management of processes to permit configuration of time to all other aspects of the system and control the functions of the user activities, for example, a calendar event, a task, etc.

The processor 108 and the memory unit 110 having instructions encoded thereon, and coupled to the processor, enable the computer automated system to control user access by means of the user interface 104. The file management system application 112 in the computer automated system generates user-specific parameters for limiting user access to specific records. Further, the processor 108 and the memory unit 110 having instructions encoded thereon enable the computer automated system to manage a specific user's time via a time keeping manager and time management application 118 and control via the file management system, at least one of a document generator 114, a conflict resolver 122, a service resolver 124 and a plurality of servers (140, 142, 144, 146 and 148) for registering a user to schedule an appointment with an attorney, conflict resolution, and resolve a case for a judge in a court room for hearing and presenting judgments. In addition, the system manages employees by providing detailed accounting of work performed including the ability to implement payroll and HR functions. Compensation for work performed by the employees is then tied to any work arrangement and compensation plan, is configurable and is programmed into the system as per the needs of the service provider (say, a law firm).

A user 102 communicates with the sub-system 106 by means of a user interface 104. The communication between the user 102 and the sub-system 106 is controlled by the file management system (FMS) desktop application 112. The file management system 112 works as an administrator and creates user identification, user groups and rights to control access to the computer automated system 106.

In communication between the user 102 and the sub-system 106 users are grouped into categories or types. In an embodiment, users are grouped into at least three different types or categories. The users' rights are set by the administrator depending upon the type or category the user belongs to. The user may be a user client, an employee, a super user etc. Further, grouped users can be sub-grouped and customized controls can be configured. Other variations and modifications are possible, as would be apparent to a person having ordinary skill in the art.

Any user who communicates and inputs a query to the sub-system 106 is identified either as a user client or administrator/employee. The administrator/employee users may be grouped into sub groups depending upon the kind of specialized services that the administrator/employee is assigned. For example, a user client requiring services related to patent, trademark, copyright, design etc. will be assigned to an administrator/employee grouped into separate sub-groups as it relates to a specialized practice area. Similarly, a user needing filing, filing and prosecution, filing and opposition, litigation services etc. will be assigned to grouped administrators/employees separately. A user client selects from a service and subservices that he/she needs. User clients are grouped collectively unless otherwise configured and grouped by the service that the user selects. The grouping process allows for detailed configuration and assignment of matters, tasks, collection of documents, communication, and security.

Once the administrator identifies the sub-group (referring here to sub groups of specialized services) that a user client selects, the administrator further assigns the user certain rights of access to the sub-system. A user may have a right to read, write or delete permission depending upon the kind of service that the user client avails from the law firm via the sub-system. If the user client registers with the system, the administrator assigns a read permission and write permission for inputting the details that the user client wishes to submit. Thus a registered user client is enabled to modify any document that the user client submits. To maintain client confidentiality, the administrator further limits the permissions of the user client by providing the user client access to only those documents related to that particular user client matter only.

However, if the user client does not wish to register with the sub-system, the user client, like any guest user, is limited to a read permission only and is not assigned any write permission. In such a case, a user client may be provided access to a fixed set of articles and documents to help the user client to decide the services that can be availed of from the service provider via the automated system.

If the administrator of the sub-system identifies the user as an employee, the user is provided rights having a combination of a read, write or delete permission depending upon the designation of the employee and his/her responsibilities in the hierarchy. For example, if the service provider is a law firm, an employee may be an executive, a paralegal, a professional, an attorney, head etc. To implement protection to a peer employee, the employee may be provided with read only access to their peers work but may not be provided permission to delete files not created by them or have any access to documents of a senior, superior, boss, etc., but may be able to access, read, write and delete files of a junior or any employee reporting to the user or designated to be lower down in the hierarchical structure. Other variations are possible as would be apparent to a person having ordinary skill in the art.

If the administrator identifies a user to have super access to the automated law firm, the user may be provided administrator equivalent permissions to such a super user. However, to protect accidental deletions or unintended actions, the super user shall be provided with an opportunity to be alerted to confirm or verify such actions by providing provisions like a pop-up message etc. Further, the administrator may limit such super users' rights by maintaining a recovery point to avoid unintentional crash or deletion.

Depending upon the user rights or permissions, alternate embodiments may provide different user interfaces by configuring or customizing the user interface for a user client, an employee or a super user to provide limited or unlimited access to the sub-system or/and service provider system.

The computer automated system is further provided with a means for communication between a client and an attorney, an attorney and a judge, and a client and a judge, via the user interface 104, and further for three way communication between the attorney, judge and client.

A user 102 or a client accesses the sub-system 106 to register within the system of the service provider. On receiving the details of the user, the FMS application 112 and a web/mail server 142 generate an email id for the user. The email-id is then sent to the user 102 to send details to activate user registration with the sub-system 106.

On receiving the email-id from the sub-system 106, the user 102 inputs the details of the case for completing the steps of registration. The FMS application 112 and a conflict resolver 122 authenticate the details of the user 102 to verify within the sub-system 106, for any conflicts. A conflict resolver 122, the FMS application 112 and an application server 140 verify the details of the user for any conflict. The conflict may be a conflict of interest, confidentiality issues or such issues that the sub-system 106 may find conflicting.

In the event the sub-system 106 returns any conflicting matter, or if a conflict is confirmed, the FMS application 112 communicates attorney service regret to the user on authenticating a conflict with the sub-system 106. However, if the details provided by the user do not generate any conflict, the user 102 selects a service being provided via the sub-system 106. In a preferred embodiment, the services offered to the user are identified into two categories, namely bundled and unbundled service.

When the user opts for bundled services, the user is provided a limited set of services, like providing the user limited information and advice for counseling the user client about the services rendered by (say) the law firm. The user may be advised with the options and the best remedy available to the user for resolving the problems at hand.

According to an embodiment, the user may seek bundled services for obtaining an uncontested divorce, i.e. divorce by mutual consent. In the given situation, there is no hostility between the two parties and both the parties agree to separate without contesting. The parties need to execute the divorce agreement by making an application for divorce, and fill in the formal documents to complete the legal procedural requirement. The required judgment is merely procedural and does not entail utilization of substantial resources. Therefore, since only basic services are required in such an instance, the user can opt for bundled services.

If the user opts for unbundled services from the law firm, the user is provided all the required services that may be rendered to the user in order to resolve a problem. The user is provided with the limitations of the matter or the situation and an action plan for the remedies that may best suit the user. The user is also provided services to provide protection or cover to the user such that the user suffers minimum penalties or punishment within the ambit of the law. The unbundled services may extend the maximum benefits to the registered user that is ethically and lawfully acceptable. Alternatively and additionally, the sub-system can be configured to calculate based on user input, services required, and present the user with a user-specific, customized offering. Other variations are possible as would apparent to a person having ordinary skill in the art.

In an embodiment, the user may seek unbundled services for obtaining a patent. The services rendered by the law firm may include providing a patent applicant a patentability search report, drafting a patent application, filing a patent application, prosecuting a patent application, filing an appeal brief, etc. Therefore the user may need extensive services from the law firm to obtain a patent or contest the validity of grant a patent, etc.

The file management system 108 generates user-specific parameters for each user at the time the user submits details for registration and chooses the type of service required from the law firm via the sub-system 106.

The sub-system 106 further comprises a country application 116 that determines the jurisdiction under which the client falls and the related applicable laws. To begin work on the case, an appointment manager application 136 schedules an appointment between the user 102 and the practitioner in the law firm. The appointment manager 136 provides optional meeting schedules to suit the client availability and timings pertaining to the case.

On the appointment scheduled by the appointment manager 136, the user 102 meets a member or practitioner of the firm via any one of the group comprising a videoconference meeting, in person or telephonically. The sub-system 106 comprises a videoconference application 120 to convene the scheduled meeting with the user 102 with any member or practitioner of the law firm.

A document generator 114 generates user specific details and forms in a non-editable structured format pertaining to a particular case after the meeting with the client is convened successfully, and keeps the documents ready for placement in a virtual court room 130 for a judge or/and jury to hear the case and deliver judgments.

In an embodiment of the invention, the generator can also communicate with the clerk of courts, file documents and return them as file stamped. The generator can also add the case number to the system for the future processing and filing of documents.

A time keeping manager 118 in the sub-system 106 keeps a track of the time utilized on a particular case and case tracker application 134 tracks the progress of every case. When the judge or/and jury in the court submits their decision to deliver a judgment, a billing generator in the sub-system 106 generates bills/invoices to the user for availing the service from the firm. The bill/invoices are generated in view of the services chosen by the user at the time of registration. The billing/invoice generator 132 gathers data from the event calendar and tasking system, whereby the administrator user may reconcile the events and tasks to populate into a billing interface. The system eliminates the need to track one's time as the scheduler in combination with the data collected in events and tasks form the basis for invoicing.

To ensure a smooth functioning and provide fall back options for the sub-system 106, the system 100 comprises a plurality of servers (140, 142, 144, 146, and 148) that are synchronized with each other and interconnected by a system bus 138.

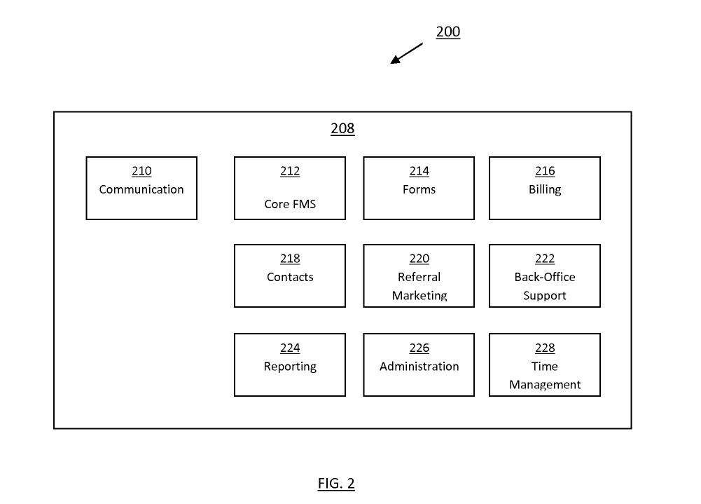

FIG. 2 illustrates a block diagram of a file management system in the automation of law firms. Shown in FIG. 2 is the file management system 208 that is the core of the system. In an ideal embodiment of the system, the file management system performs the tasks of communication 210, documentation 214, tasking, time management 228, referral marketing 220, back-office support 220, billing 216 and synchronization of files. The communication unit 210 carries out communication with the user and the internal members of the firm.

Further, as shown in FIG. 2 the file management system 208 generates the documents and forms 214 related to the client, maintains contact information 218 in an address book, provides back-office support 222 to the practitioner and also executes referral marketing 220 for the firm. In addition to the foregoing, the file management system and a core FMS 212 also generate and send reports 224 of the cases registered with the firm on a routine basis.

The purpose of the referral management system (RMS) 220 is to automate customer and referral relationships. Each referral source is noted by a data field, for example, A, B, C, D, and F. The data field indicates whether the client or referral source is someone of importance to the firm either as a whole client or as a source of business. The user/admin may elect to combine the two, but the file management system 208 allows for added grouping and separation. The data field allows the person to have access to the admin of their choosing based upon preset permissions in the configuration panel. Further, data is also collected on the client's contacts in addition to (say) date of birth (DOB), interest, hobbies, kids, education, legal matters of interest, etc. This facilitates the user/admin to group interests and select vendors for sending out communication or client gifts automatically based upon the rules assigned to the communication category.

If the user/client likes the outdoors, the file management system 208 might send them an article of interest or a link to a new product tailored to their hobby. If it is their birthday, it would send out a card through a Back Office Support (BOS) process or third party vendor. The file management system 208 would also send out tailored newsletters and firm updates based upon permissions, and depending on the type of referral source, invites to meals, and other types of gatherings. Other variations and modifications are possible, as would be apparent to a person having ordinary skill in the art.

The file management system 208 also ties into social media platforms including Facebook (R) and Twitter (R). The contacts also permit click to call, SMS, email, fax, and mobile interface. Documents, tasks, events, to do lists can be sent through the contact card interface via a click through process. This click through is also tied throughout the automated system so that the user/admin can select a default for the individual user or system for preferred method of communication.

Further, the file management system 208 performs administrative and accounting tasks. The administration unit 226 generates permissions for the users. The users are classified into different categories, for example, the person who gets to see and administer the entire backend of the system, admin UI separate, the staff interface and so on. The administration unit 226 generates the user rights, and access to the automated law firm sub-system is permission based. The hierarchy and the rights and permissions that a user has been conferred with will determine tasks the user can perform through the user interface.

The administration unit 226 can limit access of clients to documents generated by the system and can further manage the system by creating user groups and user identifications, etc. The file management system 208 includes a time management unit 228 that keeps a record of time invested in a case. This helps the practitioner estimate the effectiveness of his or her practice, further enabling him or her to determine the time being invested and the billing done on a case to case basis.

Using a combination of the aforementioned processes, automation of the practice, including client, judge, clerk of courts function and attorney is achieved on a single platform. The sub-system has incorporated within itself file synchronization, data preservation, attorney's private practice and also includes a judicial process that includes court hearings, and the clerk of court function of filing court schedule management, etc.

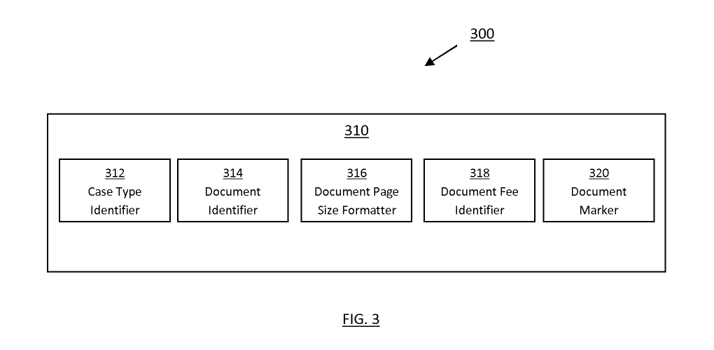

FIG. 3 illustrates a block diagram of the document generator in the automation of the law firm practice. The document generator 310 includes a case type identifier 312 unit, a document identifier unit 314, a document page size formatter 316, a document fee identifier 318 and a document marker 320. The case type identifier unit 312 generates the case identification details for identifying the case type. For example, if the case is related to Intellectual Property Rights (IPR), the domain of the case type is identified viz., Patents, Trademarks, Copyright, or Trade Secrets, as the case may be.

Similarly, a document identifier unit 314 identifies the type of document or form that needs to be generated for a certain offence, objection, compliance etc. For example, whether an affidavit, a fine, a petition, an appeal, a proof of payment etc. needs to be furnished or submitted.

Shown in FIG. 3, a document page size formatter 316 identifies the kind of document that needs to be generated as stipulated by law. Depending upon the document generated, a document fee identifier 318 indicates to the billing/invoice generator in the law firm to raise bills/invoices to the client according to the service chosen by them. Further FIG. 3 shows a document marker 320 in the document generator 310 that includes markers or book marks for making sure the documents are filed with the clerk and putting the case to the judge in the court room 136 at the time of hearing or judgment.

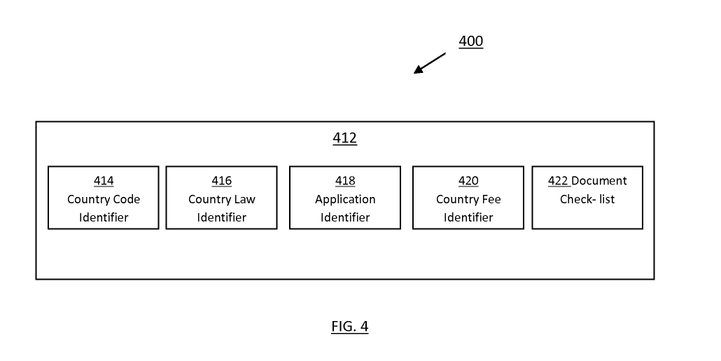

FIG. 4 illustrates a block diagram of the jurisdiction identifier. The jurisdiction identifier 412 comprises a country code identifier tag 414 to identify the country to which the matter belongs. This enables delivery of services to the clients across the globe. Once the country is identified, a country law identifier 416 determines the section or jurisdiction laid down by the constitution of the identified country. Further, the case submitted by the client for each country is tagged with an application identifier 418, a country fee identifier 420 and a document check-list 422 for fulfilling all the formal requirements to be complied.

The sub-system may be integrated on different models. In an exemplary model, the sub-system may be part of a an automated system for a law firm having a registered head office and branch offices providing services in the various jurisdictions. For example, if the courts in the particular country are identified by different zones and maintain a hierarchy, then the firm may extend their services through the branch offices.

In another exemplary model of the firm, the firm may work through a network of associates that helps the firm to spread presence of services in a larger domain and at the same time also increase clientele. The firm benefits in this model that the core competencies of the firm are enhanced and the best service may be made available readily to the user.

In yet another embodiment, the firm may be based on a model to provide a global presence. The law firms having global presence may offer services to the clients in the jurisdictions in which the firms operate. The law firms may operate from one location, and offer services in multiple jurisdictions. For example, a firm may operate from San Francisco, Calif., and a client's matter will be put before a judge in Houston, Tex. The global model may also enable the firms to have a competitive advantage over other firms and adopt cost control measures by outsourcing or sending work off shore or eliminating the need for large offices allowing work from home opportunities.

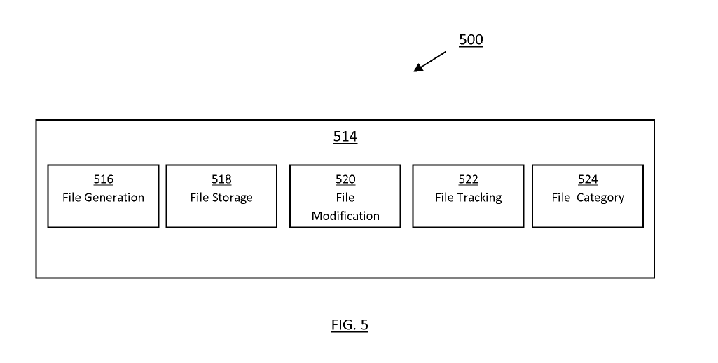

FIG. 5 illustrates the working of the file management application 514 in the sub-system. A file management application generates a file 516 having unique identifier that helps to docket a file uniquely by the client name and the number of cases provided by the client. Once the file is generated by the file management application 514, the file is allocated to the respective department in the law firm. For example, if the file is related to Intellectual Property Rights (IPR), the department of the file type is identified viz., Patents, Trademarks, Copyright, or Trade Secrets. Further, Patents can be identified with Prosecution or Litigation, as the case may be, and so on.

As the matter progresses to a hearing or a judgment, the files get updated and need to be modified regularly. The file management application comprises a file modification application 520 that can update the incremental modifications in the file. A file tracker 522 maintains a track of the file status and the next action that is to be taken on a future date. Thus, the file tracker 522 is capable of generating reports on a daily, weekly, monthly, quarterly, half-yearly or yearly basis for the concerned departments to take action. A file category application 524 further maintains the records of the file under the category that the files are active, expired or closed case.

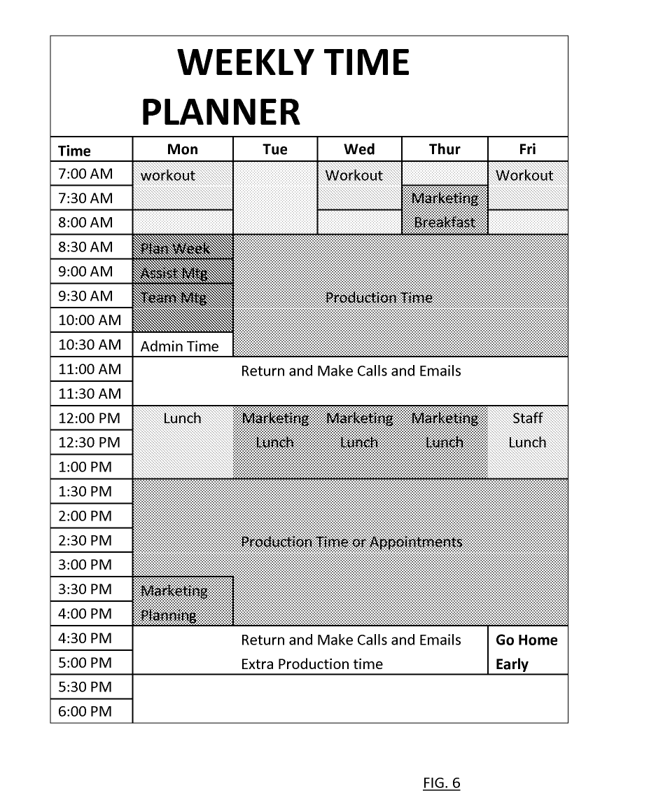

FIG. 6 illustrates a block diagram illustrating the time block scheduling system that integrates time block scheduling system with the calendar and tasking. The time block scheduling system is compatible and synchronizes with Outlook (R) or Imap/Mac (R) formats. The time block scheduler enables a user to keep a track of time invested in a file and to grant permission based access to one's calendar based on the time type. Further, the time block scheduler permits the administrator/user to create types of time, production, return calls, appointments, meetings, administrative functions, etc. The time type is then inserted in a week view calendar. The time block scheduling system has the advantage of improved time scheduling and time management that provides the user/administrator to provide appointments and maintain schedules.

The admin user, based on type, provides a default setting on their calendar for the blocks of time as shown. The default calendar is customizable by the admin user and is provided to each admin interface/user profile. By providing a customizable calendar a user systematically schedules and allows user/clients to schedule meetings on the front end with the admin of their choice. In addition, the admin allows the super admin to create different categories of time and use color codes. The individual admin then chooses the category for the time slot. However, this is limited only for establishing time slots for scheduling purposes as all calendar events are inserted by the calendar owner or another user with the correct permission.

Once the types of time are inserted as disclosed above, the system then permits the user to create task types and then the various associated tasks within the type group. This allows the tasks to be quantified and be configured in time, for example, client appointments 30 minutes, etc. The time configuration also allows a user/admin to publish the type of time on the display to the type of user/client. Client users, for example, may only be able to schedule appointments; a secretary user would be able to add production, appointments, etc. Such provisions are permission keyed, read, write, delete, etc. The time types are also tied to services and this data is also sent to billing and invoicing.

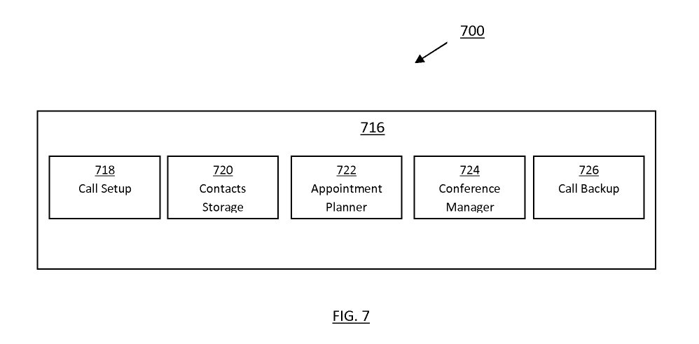

FIG. 7 is a block diagram illustrating the working of a videoconferencing application. The videoconferencing application 716 convenes a scheduled meeting between the user with any member or practitioner of the law firm. The videoconference application comprises a call setup unit 718, a contact storage unit 720, an appointment planner 722, a conference manager 724 and a call backup unit 726. The call setup unit 718 sets up the conference call on the scheduled appointment. Further, the videoconferencing application includes a contacts storage unit 720 that stores a record of all the conference call numbers and contacts.

The appointment planner 722 keeps a track of the appointments for the future calls and reserves a conference room for the participants. The conference manager 724 schedules and confirms the appointments by email with the participants of the conference call. To maintain a record of the videoconference calls and participants the call backup 726 records the videoconference meetings that is stored in the storage device for later reference.

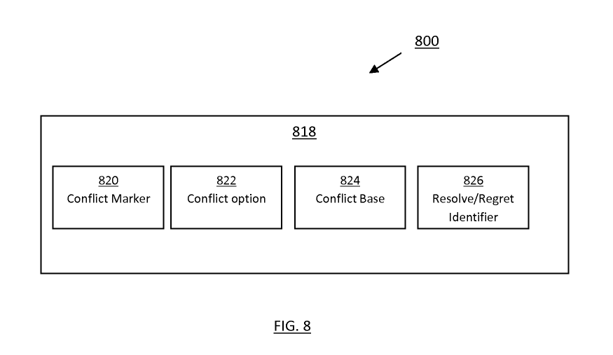

FIG. 8 illustrates a block diagram of the conflict resolver. A conflict resolver 818 comprises a conflict marker 820, a conflict option 822, a conflict base 824 and a resolve/regret identifier 826. The conflict marker 820 indicates a conflict to the file management system in the event of a conflict. On receiving a conflict the file management system determines the options to resolve the conflict using a conflict option application 822. Further, the conflict resolver maintains a history of all the conflicts and the possible solutions to sort the conflicts in the conflict base 824. When the conflict resolver 818 is capable of sorting a conflict, it reserves a conflict identifier to sort similar conflicts. However, when the conflict remains unresolved, the regret identifier is marked to refuse services of similar nature in future. Thus a resolve/regret identifier 726 improves the efficiency of the law firm in resolving conflicts for future.

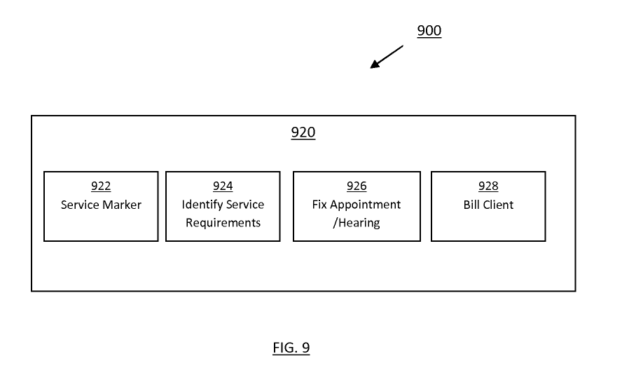

FIG. 9 illustrates a block diagram of the service resolver. A service resolver 920 comprises a service marker 922, a service requirement identifier 924, appointment/hearing scheduler and a client billing indicator 928. The service marker 922 indicates the different types of services that a law firm has on offer to the client. Each service is categorized on the basis of complexity and recurrence of the kind of service. This helps the practitioner to bundle and draw an estimate of the services to be rendered to the client. When the user identifies the services required, the service resolver 920 sets up optional dates for scheduling an appointment with any member of the firm or to attend a hearing in the virtual court room in the presence of the attorney and the judge. The service resolver 920 also includes a client billing indicator 928 that indicates to the billing/invoice manager to raise bills/invoices when an appointment/hearing is concluded.

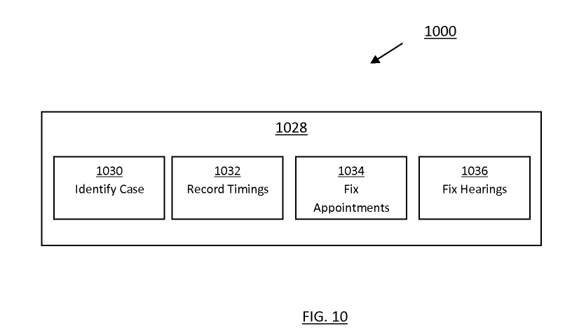

FIG. 10 illustrates a block diagram of the time keeping manager. A time keeping manager comprises a case identifier 1030, a timing recorder 1032, an appointment scheduler 1034 and a hearing scheduler 1036. The case identifier 1030 identifies the case as it is taken up for prosecution (say) or litigation, as the case may be, and the timing recorder 1032 keeps a record of time spent on the case at various stages of the case. The appointment scheduler 1034 and the hearing scheduler 1036 fix slots for the scheduling appointments for meetings and hearing of the case respectively.

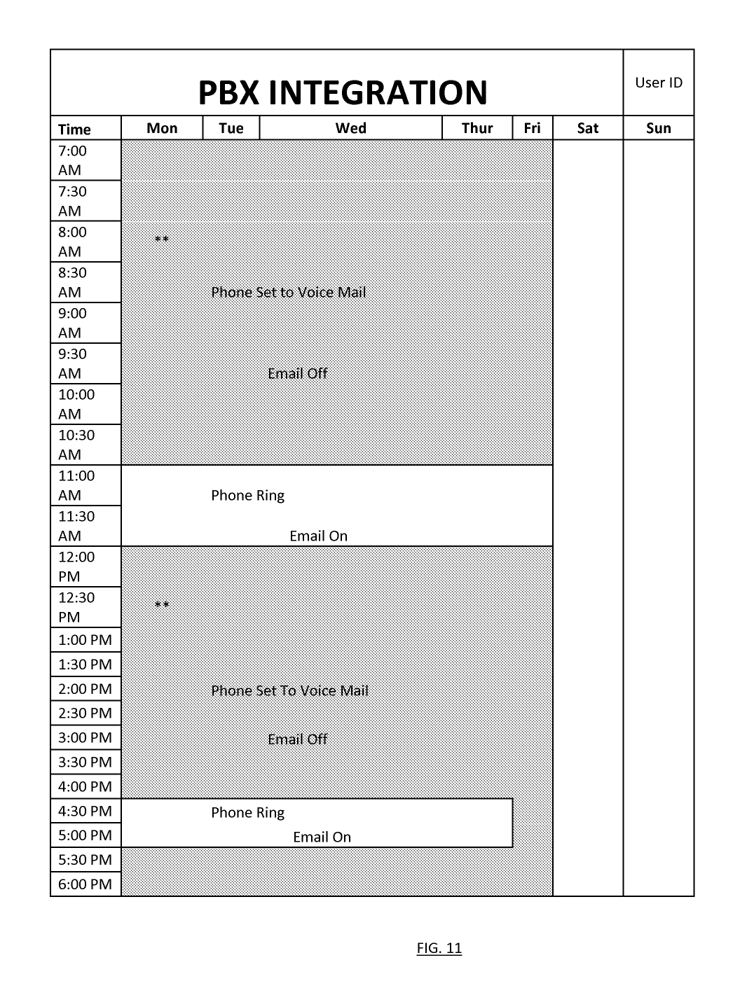

FIG. 11 illustrates an example of the different categories of time types for a user. As shown in FIG. 11, the time type is tied to the telephone system. In this way, the time type is tied to “return calls and emails” so that the phone and email system turn on during specified hours only. The provision of the time type system allows certain contacts from the system to be set to ring through during non-type times. A contacts interface within the contact panel enables a user admin to categorize the user/client by assigning the contact to a priority code, A, B, C, D, E, F, etc. Such contacts will be identified in the contact pad as a priority contact whose number or email cannot be masked by the system in order to provide them a high non-maskable priority. Based on the code given, the contact can go through to an admin. For example, an “A” code allows the user to get to the file/client supervisor, a “B” code to the second in command, etc. An “F” code goes to the messaging system until qued for the designated time period. The default setting is to follow the rules established in this figure. Only after a contact is added to a system, can they be assigned a priority code. The contact interface is compatible and synchronizes with the existing email systems for example, Outlook (R), Gmail (R), or other system via synchronization application.

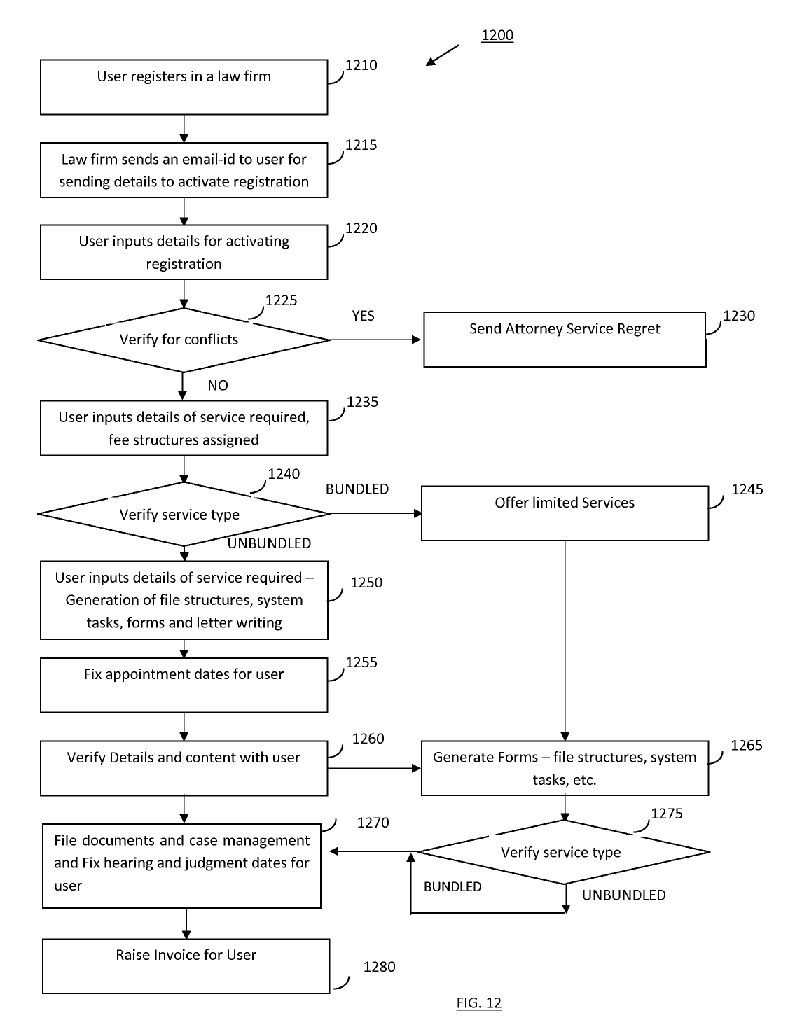

FIG. 12 illustrates the method of automation of a service provider process flow, in this case a law firm in an embodiment. FIG. 12 illustrates a flowchart for the method 1000 of automating. A user interfaces with an automated law firm sub-system to register (1210) the user to resolve a case and schedule to a judge in the court for hearing and presenting judgments.

Step 1210 involves registering, via a user interface, with a law firm to resolve a case and ultimately schedule a hearing for resolution/judgement in a court.

Step 1215 entails sending an email id to a registered user for activating their registration. In an embodiment, the user responds by submitting their details using the sent email id, for activating their registration.

In step 1220, the user submits details for activating user registration.

Step 1225 involves authenticating the submitted user details to verify for conflicts with the law firm, if any.

Step 1230 involves communicating, by the file management system, attorney services regret to the user on authenticating a conflict.

In step 1235, authenticated user input details are submitted to the file management system. The user inputs details of services required so that a fee structure can be assigned by the sub-system.

Step 1240 entails verifying whether the services required by the user are a bundled or unbundled service.

Step 1245 involves offering limited service to the user when the user chooses bundled services.

Step 1250 involves submitting by the user, the details of the case and the services required.

Step 1255 involves offering extensive services to the user if the user chooses unbundled services, and scheduling an appointment between the user and a member of the firm via the automated law firm sub-system.

Step 1260, involves convening a meeting with a member of the law firm to verify details of the user and the case details, wherein the meeting is convened using any one of the modes i.e. a videoconference meeting, in person or telephonically.

Step 1265 involves generating the documents (such as file structures, system tasks, etc.) of the case in a non-editable format for presenting to a judge in a virtual court-room.

Step 1270, involves filing documents and case management records with a/the clerk of courts, receiving hearing and judgment date options, and setting up a real or virtual meeting between the client/attorney, and the (virtual) court via the clerk or clerk interface.

Step 1275 involves verifying the service detail when judgment is delivered by the judge in the court.

Step 1280, invoice involves raising an invoice 1280 to the user for the services availed by the user.

The advantages of the system and method as disclosed in the foregoing is that the service provider practitioner is equipped with tools for tracking and managing his/her time and it makes billing extremely easy. Furthermore, the sub-system can be customized to any kind of case for example, wills, trusts, estates, litigation, serving to expedite a court process and synchronize any court system. Alternatively, and additionally, the system disclosed can be customized to automate the provision of any type of service, legal or otherwise, as would be apparent to a person having ordinary skill in the art.

Embodiments provide an improved registration of a case, providing improved service, proper time management and thereby increased efficiency and effectiveness while maintaining client confidentiality of the law firm.

In the preceding description, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of the present disclosure.

I/We claim:

1. A system for automating a plurality of tasks in the provision of legal services, the system comprising:
a processing unit coupled to a memory element, and having instructions encoded thereon, wherein the instructions enable the system to:
control user access via a user interface;
generate user-specific parameters by a file management system application for user specific access;
manage a specific user's time via a time keeping manager; and
control, via the file management system, at least one of a document generator, a conflict resolver, a service resolver, the time keeping manager and a plurality of servers for registering a user to schedule an appointment with an attorney, and filing of documents with a clerk of courts to resolve a case for a judge hearing and presenting judgments.

2. The system of claim 1, wherein the instructions further enable the system to control user access via the file management system.

3. The system of claim 1, wherein the instructions further enable communication between at least one of a client and an attorney, an attorney and a judge, and a client and a judge courtroom, via the user interface.

4. The system of claim 1, wherein the instructions further enable the system to receive user/client input details for registration with an attorney or attorney firm.

5. The system of claim 1, wherein the instructions further enable generating and sending an email-id to the user by the file management system to send details to activate user registration with the law firm.

6. The system of claim 5, wherein the instructions further enable the system to check for conflicts, and for conflict resolution and user authentication to verify for conflicts with the law firm.

7. The system of claim 6, wherein the instructions further enable the system to communicate attorney service regret to the user on authenticating a conflict with the law firm.

8. The system of claim 6, wherein the instructions further enable the system to facilitate user selection of a service provided on being authenticated with the law firm.

9. The system of claim 8, wherein the instructions further enable the system to present the user with at least one of a bundled and unbundled service.

10. The system of claim 1, wherein the instructions further enable generation of user-specific parameters to access the legal services.

11. The system of claim 1, wherein the instructions further enable determining a country specific jurisdiction from a plurality of country applications.

12. The system of claim 1, wherein the instructions further enable scheduling an appointment between a user client and a provider of the legal services by an appointment manager application.

13. The system of claim 12, wherein the instructions further enable facilitating a meeting between a client user with the legal services provider user by any one of the group comprising a videoconference meeting, in person or telephonically.

14. The system of claim 13, wherein the instructions further enable facilitating a videoconference meeting of the client user with a member of the firm providing the legal services.

15. The system of claim 12, wherein the instructions further enable scheduling appointments between the client user and the legal services provider by an appointment manager.

16. The system of claim 12, wherein the instructions further enable generating user specific details and structuring the details for placement in the court room by a document generator.

17. The system of claim 1, wherein the instructions further enable creating user groups and user identification by the file management system.

18. The system of claim 1, wherein the instructions further enable tracking time utilized on a particular case by the time manager, and for tracking the progress of every case by a case tracker.

19. The system of claim 18, wherein the instructions further enable raising invoices using a billing generator.

20. The system of claim 1, wherein the instructions further enable synchronizing the plurality of servers with each other and a system bus for interconnecting the components of the automated law firm with the plurality of servers.

21. In a computer automated system comprising a processor and a memory with instructions encoded thereon, a method for automating the provision of legal services, comprising:
controlling user access via a user interface;
generating user-specific parameters by a file management system application for user specific access;
managing a specific user's time via a time keeping manager; and
controlling, via a file management system, at least one of a document generator, a conflict resolver, a service resolver, the time keeping manager, and a plurality of servers for registering a user to schedule an appointment with an attorney, and filing of documents with a clerk of courts to resolve a case for a judge hearing and presenting judgments.

22. The method of claim 21, further comprising registering a user with the computer automated system via a user interface.

23. The method of claim 21, further comprising activating the user registration, which comprises generating and sending an email-id to the user for submitting details to the computer automated system.

24. The method of claim 23, further comprising activating user registration upon receiving user details submitted from the generated email-id.

25. The method of claim 24, further comprising authenticating the details submitted by the user to verify for conflicts.

26. The method of claim 25, further comprising communicating attorney services regret to the user on entering a conflict.

27. The method of claim 25, further comprising determining the services provided to the user wherein the user submits details on being authenticated.

28. The method of claim 27 further comprising providing at least one of bundled and unbundled service to a user.

29. The method of claim 28, further comprising facilitating a meeting between a client user with an attorney or attorney firm user by any one of group comprising a videoconference meeting, in person or telephonically.

30. The method of claim 29, further comprising verifying the service details to provide hearing and judgment dates options to the user.

31. The method of claim 30, further comprising raising invoices to the user for the services availed by the user.
